(19) United States
(12) Patent Application Publication
(10) Pub. No.: US 2020/0195084 A1
(43) Pub. Date: Jun. 18, 2020

(54) MEANDERING COOLANT CHANNELS WITH VARYING WIDTHS IN A MULTI-SECTION MOTOR HOUSING

(71) Applicant: Thunder Power New Energy Vehicle Development Company Limited, Central (HK)

(72) Inventor: Frank LIN, Taipei City (TW)

(21) Appl. No.: 16/702,580

(22) Filed: Dec. 4, 2019

Related U.S. Application Data
(60) Provisional application No. 62/778,874, filed on Dec. 12, 2018.

(51) Int. Cl. H02K 5/20; H02K 1/27; H02K 9/193; H02K 21/14; H02K 7/00; B60K 1/00

(52) U.S. Cl. CPC H02K 5/20; H02K 1/276; H02K 9/193; B60K 2001/006; H02K 7/006; B60K 1/00; H02K 21/14

(57) ABSTRACT

A housing for cooling an electric motor in an electric vehicle includes a tubular frame with a first end and a second end, where the first end has first openings, the second end has second openings, and the tubular frame has first channels encased in the tubular frame running between the first openings and the second openings. The housing also includes a first cover that mates with the first end of the tubular frame and includes third openings positioned to mate with the first openings, and second channels that connect the first openings together. A second cover mates with the second end of the tubular frame and has fourth openings positioned to mate with the second openings of the tubular frame, and third channels that connect the second plurality of openings together. The first channels, the second channels, and the third channels form pathways through which coolant can flow.

### CROSS-REFERENCES TO RELATED APPLICATIONS

The present application claims priority to U.S. Patent Application No. 62/778,874, filed on Dec. 12, 2018, entitled “MEANDERING COOLANT CHANNELS WITH VARYING WIDTHS IN A MULTI-SECTION MOTOR HOUSING”, which is incorporated by reference herein for all purposes.

### BACKGROUND

Internal permanent magnet (IPM) motors are synchronous motors with rotating magnetic fields that have magnets embedded in the rotors of the motor. These motors can use both the torque due to the magnet magnetization and the reluctance torque due to the rotor magnetization. Since the magnets are typically embedded in rotors made from robust materials, such as silicon steel plates, the centrifugal force during the motor rotation typically does not dislodge the magnets from their positions, which results in high mechanical stability. Some IPM motors allow for control of the current phase to run with high torque over a wide range of speeds. This makes these motors very energy-efficient, while still allowing for a high torque output. Recently, the use of IPM motors has been expanding rapidly in electric vehicles, hybrid vehicles, and/or other transportation applications.

One of the challenges that arises during the use of IPM motors is that the use at high speeds found in many motor vehicle applications often involves difficulties in cooling the motor consistently and evenly. During normal operation, waste heat may be produced by the IPM motor through the relative motion of the stator and/or rotor. Therefore, most motors are equipped with an appropriate cooling system that circulates coolant in, around, or through channels in the motor. Without optimized cooling, excessive temperatures can affect the efficiency of the motor and lead to dangerous operating conditions. Therefore, improvements are needed in the art for designing cooling channels that are both effective at circulating coolant and easy to manufacture and assemble.

### BRIEF SUMMARY

In some embodiments, a housing for cooling an electric motor in an electric vehicle may include a tubular frame that may include a first end and a second end. The first end may include a first plurality of openings. The second end may include a second plurality of openings. The tubular frame may include a first plurality of channels encased in the tubular frame running between the first plurality of openings and the second plurality of openings. The housing may also include a first cover configured to mate with the first end of the tubular frame. The first cover may include a third plurality of openings positioned to mate with the first plurality of openings of the tubular frame, and a second plurality of channels that connect ones of the first plurality of openings to others of the first plurality of openings. The housing may also include a second cover configured to mate with the second end of the tubular frame. The second cover may include a fourth plurality of openings positioned to mate with the second plurality of openings of the tubular frame, and a third plurality of channels that connects ones of the second plurality of openings to others of the second plurality of openings. The first plurality of channels, the second plurality of channels, and the third plurality of channels may form pathways through which coolant can flow.

In some embodiments, an interior permanent magnet (IPM) motor may include a stator having a plurality of conductors, where the stator is disposed concentrically around an axis. The motor may also include a plurality of rotors disposed concentrically around the axis inside of the stator. The motor may also include a housing disposed concentrically around the axis. The housing may include a tubular frame that may include a first end and a second end. The first end may include a first plurality of openings. The second end may include a second plurality of openings. The tubular frame may include a first plurality of channels encased in the tubular frame running between the first plurality of openings and the second plurality of openings. The housing may also include a first cover configured to mate with the first end of the tubular frame. The first cover may include a third plurality of openings positioned to mate with the first plurality of openings of the tubular frame, and a second plurality of channels that connect ones of the first plurality of openings to others of the first plurality of openings. The housing may also include a second cover configured to mate with the second end of the tubular frame. The second cover may include a fourth plurality of openings positioned to mate with the second plurality of openings of the tubular frame, and a third plurality of channels that connects ones of the second plurality of openings to others of the second plurality of openings. The first plurality of channels, the second plurality of channels, and the third plurality of channels may form pathways through which coolant can flow.

In any embodiments, any of the following features may be included in any combination and without limitation. The first plurality of channels may be narrower than the second plurality of channels. The first plurality of channels may include alternating pairs of channels, where coolant may flow in same directions in each of the pairs of channels. Each of the pairs of channels in the tubular frame may include a space between the pairs of channels, where the space may be less than 25% of a width of one of the first plurality of channels. The third plurality of openings in the first cover comprises pairs of openings, wherein each of the pairs of openings receive coolant flowing in same directions. Each of the second plurality of channels in the first cover may connect ones of the pairs of openings in the first cover to others of the pairs of openings in the first cover. Each of the second plurality of channels may include a first section, a second section, and the third section, where the second section may connect the first section to the third section, and where the second section may be narrower than the first section and the third section. The second plurality of channels may extend to cover a portion of the first and of the tubular frame. The second cover may include an inlet valve and an outlet valve. The coolant may flow in through the inlet valve, through the first plurality of channels, the second plurality of channels, and the third plurality of channels, and out through the outlet valve.

### BRIEF DESCRIPTION OF THE DRAWINGS

A further understanding of the nature and advantages of the present disclosure may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified block diagram of an electric vehicle, according to some embodiments.

FIG. 2 illustrates a schematic of the motor, according to some embodiments.

FIG. 3 illustrates an exploded view of a motor assembly that includes a detailed view of the housing, according to some embodiments.

FIG. 4 illustrates front and rear views of an assembled motor assembly, according to some embodiments.

FIG. 5 illustrates an internal diagram of the different channels in the housing through which coolant can flow, according to some embodiments.

FIG. 6 illustrates how the first cover and the second cover can be mated with the tubular frame, according to some embodiments.

FIG. 7 illustrates a cross-sectional view of the front cover, according to some embodiments.

FIG. 8 illustrates a cross-sectional view of the motor assembly in a plane that includes or is parallel to the central axis of the motor assembly, according to some embodiments.

### DETAILED DESCRIPTION

Described herein, are embodiments for a motor housing with integrated cooling channels that provide a thorough and efficient pathway for liquid coolant to flow around an electric motor. According to some embodiments, the housing may include a plurality of sections, including a hollow tubular frame and first and second covers that can be mated with the tubular frame. Because the tubular frame is hollow, the stator and rotors of the engine can be inserted inside the hollow tubular frame. Encased within the wall of the tubular frame, some embodiments may include a plurality of channels that run parallel to a central axis of the tubular frame. Each of these channels may include an opening at each end of the tubular frame. A front, or first cover may include a plurality of openings that mate with the openings on the tubular frame formed by the frame's channels. The first cover may include another (second) plurality of channels that connects sets of its openings in the tubular frame together. The channels in the first cover may extend in a plane that is perpendicular to the axis of the tubular frame, allowing the channels to cool the motor along the front side and in a direction that is different from the channels in the tubular frame. Additionally, the housing may include a second, or back cover that also includes openings that mate with the channel openings in the tubular frame. The second cover may also include another (third) plurality of channels that connect sets of openings in the tubular frame together in the second cover. When assembled, the first and second covers and the tubular frame connect the various channels embedded within each component together to form a continuous pathway through which liquid coolant can flow in alternating directions up and down the length of the housing, as well as along the front cover of the housing to efficiently and effectively cool the motor. Some portions of this continuous pathway may be narrower than other portions, which may create a pressure differential and help move the coolant through the pathway.

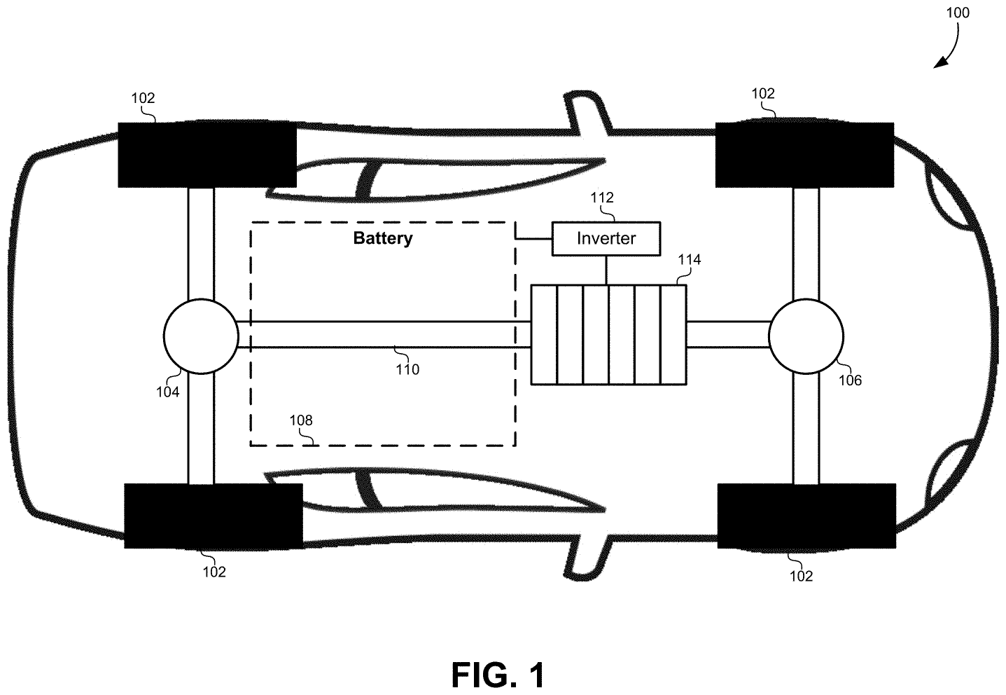

FIG. 1 illustrates a simplified block diagram of an electric vehicle 100, according to some embodiments. High-intensity permanent magnets enable technological advances for developing small, high-powered IPM motors for many different high-volume applications. One of the most important areas of IPM development is in the drivetrain of hybrid or electric vehicles. IPM motors are particularly well-suited for the electric vehicle drivetrain because they generally produce high output torque given the small physical size of the motor, while using a relatively small input voltage. IPM motors are also very mechanically reliable because the internal placement of the magnetic bars are generally very secure and withstand the high rotation rates of the rotors.

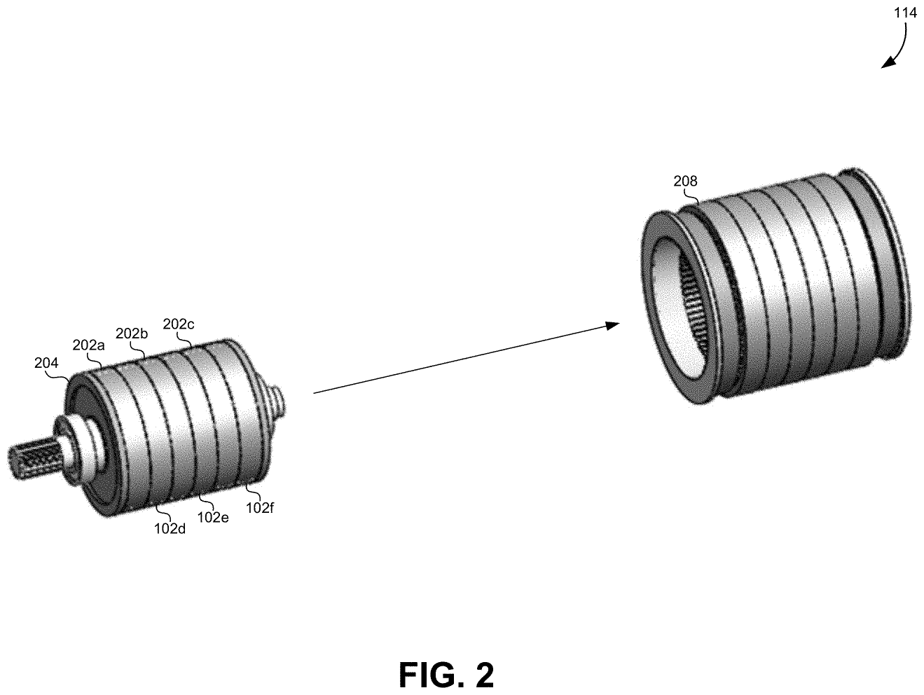

In FIG. 1, an electric vehicle 100 is depicted having an IPM motor 114. The motor 114 includes a plurality of individual rotors that are stacked together on axis and inserted into a hollow stator, which will be described in greater detail below in relation to FIG. 2. The motor 114 may be powered by a rechargeable battery 108. The rechargeable battery 108 may be constructed from a large number of individual lithium-ion cells, for example. Each of the individual battery cells may be connected in series/parallel combinations to provide a large amount of instantaneous current to the motor 114. The electric vehicle 100 may also include an inverter 112 that generates one or more AC voltage signals that may be used to drive the motor 114. For example, magnets in the rotors of the motor 114 may be used to generate a constant motor flux, while the AC current provided by the inverter 112 generates the rotating magnetic field the causes the magnets to rotate the rotors based on the speed of the field rotation.

The electric vehicle 100 may also include a drive shaft 110 that may include one or more differential units 104, 106, axles, and/or steering mechanisms. The drive shaft 110 may be rotated by virtue of its connection to the rotors of the motor 114. The differential units 104, 106 can translate the axial rotation of the drive shaft 110 into a corresponding rotation of the wheels 102. FIG. 1 illustrates how the battery 108 provides electrical power through the inverter 112, and how the motor 114 converts the electrical power into physical rotation of the rotors to turn the drive shaft 110 and the wheels 102. It should be noted that in some embodiments, the motor 114 may also be configured to operate as an energy generator in hybrid electric vehicles when the wheels 102 are turned by an external power supply, such as an internal combustion engine.

FIG. 2 illustrates a schematic of the motor 114, according to some embodiments. The motor 114 may include a stator 208 and a rotor assembly 204, along with other electrical and/or mechanical components. An IPM motor 114 is powered by an AC voltage source and uses magnets embedded in the interior of the rotor assembly 204 to respond to a rotating magnetic field generated by the windings in the stator 208. The flow of electric current through the stator 208 creates a magnetic field. The AC current flowing through the windings of the stator 208 generates a magnetic field according to Maxwell's well-known equations of electromagnetics. This generates a magnetic flux defined as the rate of a magnetic field flowing through a cross-sectional area of the internal space defined by the stator 208. Magnetic flux may also be generated by the permanent magnets embedded in the rotor assembly 204. Flux linkage occurs when a magnetic field interacts with another material, and here generally refers to how well the magnetic flux generated inside the motor 114 is translated into rotational motion of the rotor 204 assembly. In some embodiments, the rotor assembly 204 may include a plurality of individual rotors 202a, 202b, 202c, 202d, 202e, 202f that are assembled together on a central axis or shaft. Similarly, the stator 208 may also include a plurality of windings and/or rings that are assembled together such that the rotor assembly 204 can be inserted inside of the stator 208.

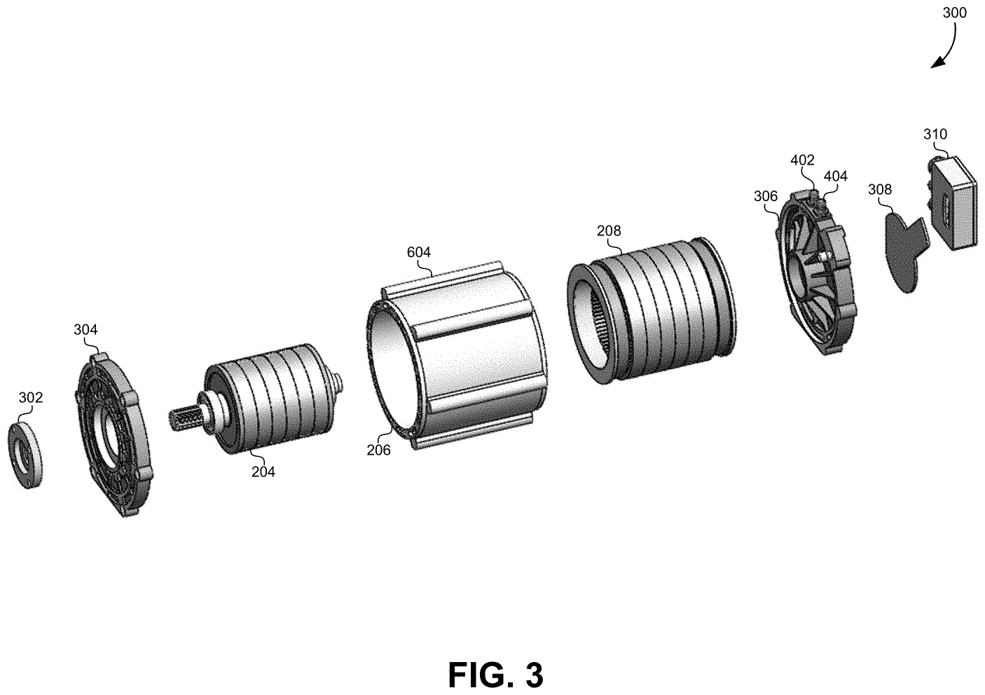

FIG. 3 illustrates an exploded view of a motor assembly 300 that includes a detailed view of the housing, according to some embodiments. This figure includes the rotor assembly 204 and the stator 208 from FIG. 2. When the rotor assembly 204 is inserted into the stator 208, this combination can also be inserted into a housing designed to protect and encase these interior components of the electric motor. The combination of the rotor assembly 204, the stator 208, and the housing may be referred to as a motor assembly 300. The housing may also be designed with features that mount the motor assembly 300 to the interior of the electric vehicle 100. The housing may also include electrical and/or mechanical connections to interface with other systems in the electric vehicle 100.

The housing may include a plurality of individual sections or components. For example, the housing may include a tubular frame 206. The tubular frame 206 may include a first end and a second and that are open such that the tubular frame 206 forms a tube with a hollow center in which the rotor assembly 204 and stator 208 can reside. The tubular frame 206 may generally be shaped as an open cylinder. It may have a cross-sectional area that forms in approximately circular ring. “Approximately circular” means that minimum and maximum axes of the interior of the cross-sectional area are within 10% of each other. Note that the tubular frame 206 may include irregular protrusions and/or other features that can be used in the assembly and/or mounting process. For example, the tubular frame 206 may include a plurality of ridges 604 that can be used to mount the housing and/or connect the tubular frame 206 to other components of the housing as described in greater detail below. The tubular frame 206 may include a substantially smooth and circular interior that is sized and configured to accept the stator 208 in a secure position.

The housing may also include a front cover referred to herein as a “first cover” 304. The first cover may be configured to mate with the tubular frame 206 such that the first cover 304 substantially covers the front open end of the tubular frame 206. The first cover 304 may include an opening through which the axis of the rotor assembly 204 may protrude. A front bearing cover 302 can be secured to the axle of the rotor assembly 204 to hold the rotor assembly 204 in place relative to the first cover 304. As described in detail below, the first cover 304 may include openings and internal channels through which coolant may be received from corresponding channels in the tubular frame 206.

The housing may also include a rear or “second cover” 306. The second cover may be configured to mate with the tubular frame 206 such that the second cover 306 substantially and/or completely covers the rear end of the tubular frame 206. As with the first cover 304, the second cover 306 may also include openings and internal channels through which coolant may be received from corresponding channels in the tubular frame 206. Additionally, the second cover 306 may include electrical and/or mechanical interfaces to interact with other systems on the electric vehicle 100. For example, the second cover 306 may include an outlet valve 402 and/or an inlet valve 404 through which coolant may flow into its internal channels. The second cover 306 may also be coupled with a rear cover or resolver 308 to cover a central hole in the second cover 306. The second cover 306 may also be coupled with a power box 310 that receives electrical energy from the rechargeable battery 108. Wiring from the power box 310 can pass through a gap left by the rear cover 308 into the stator 208 to power the electric motor.

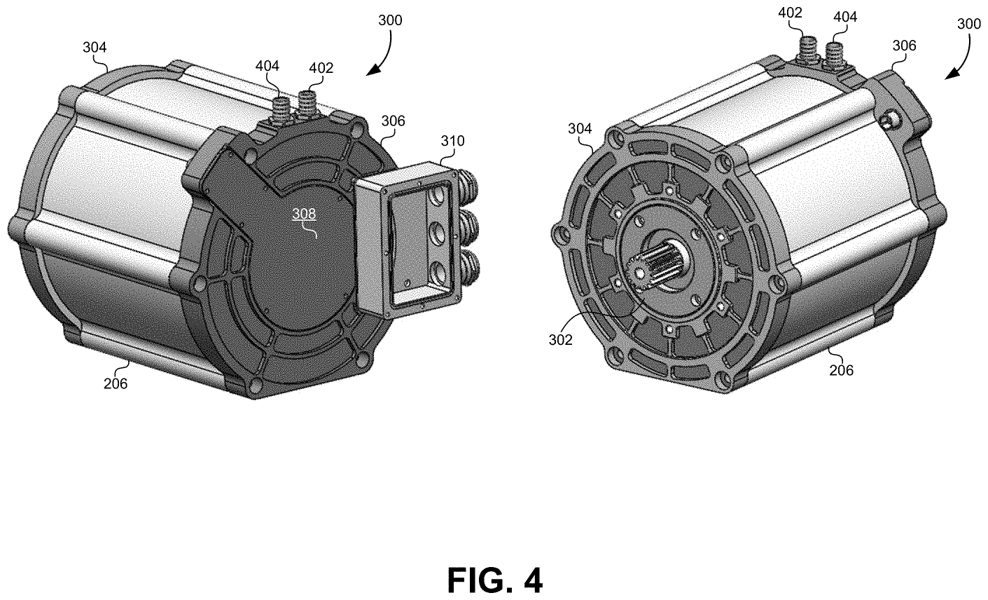

FIG. 4 illustrates front and rear views of an assembled motor assembly 300, according to some embodiments. Note that the front bearing cover 302 couples with a bearing on the axle of the rotor assembly 204 to seal the first cover 304 around the axle. The first cover 304 may be screwed, bolted, welded, or otherwise attached to the tubular frame 206 by virtue of the mounting holes that are distributed circularly around an outer circumference of the first cover 304. Note that the bottom of the first cover 304 may include a section that is substantially flat.

This section may be configured to be fixed to a portion of the electric vehicle 100. The substantially flat portion may extend along the bottom of the tubular frame 206 and the second cover 306 although not shown explicitly in FIG. 4.

In a similar fashion, the second cover 306 can be screwed, bolted, welded, or otherwise attached to the tubular frame 206 by virtue of corresponding mounting holes that are distributed circularly around an outer circumference of the second cover 306. The rear cover 308 can be used to seal the second cover 306 and allow for routing of wires from the power box 310 to the stator 208. The inlet valve 404 and the outlet valve 402 may also be an integrated part of the second cover 306. As described in greater detail below, these valves 402, 404 can be coupled to hoses or tubes that provide liquid coolant to the motor assembly 300. Coolant can flow in through the inlet valve 404, circulate through internal channels inside the second cover 306, pass into internal channels in the tubular frame 206, and travel through internal channels in the first cover 304. The connections of these three members of the housing combine to form a continuous channel through which coolant can flow, eventually exiting through the outlet valve 402.

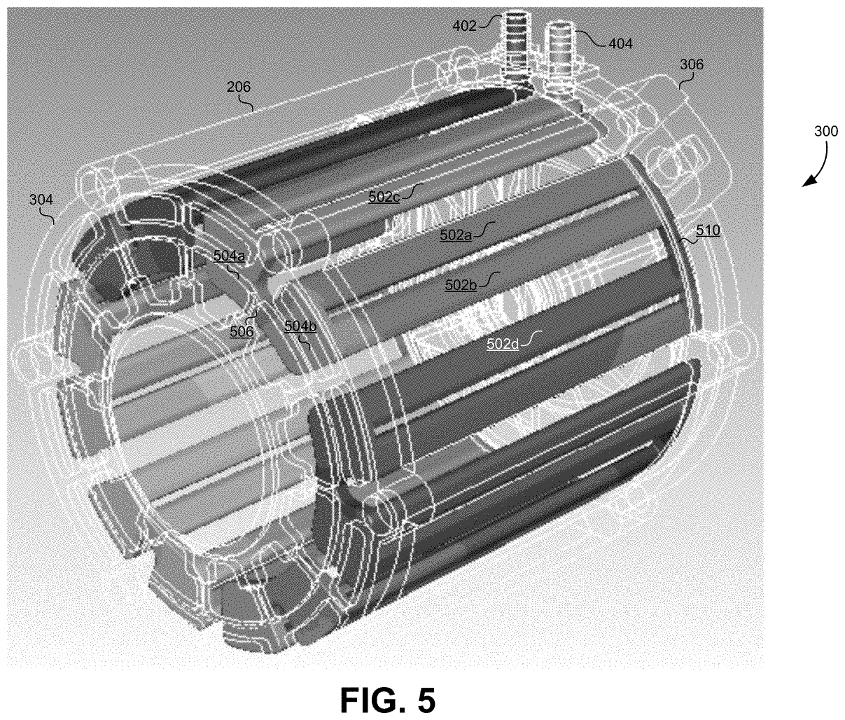

FIG. 5 illustrates an internal diagram of the different channels in the housing through which coolant can flow, according to some embodiments. The tubular frame 206 includes a plurality of channels that are circularly distributed around the wall of the tubular frame 206. The plurality of channels encased in the wall of the tubular frame 206 may be referred to herein as a “first plurality of channels” to distinguish these channels from other channels that exist in the first cover 304 and/or second cover 306. Each of the first plurality of channels may have any shape that may fit within the wall of the tubular frame 206. For example, a cross-sectional view of the first plurality of channels may be substantially circular or oval. In the embodiment illustrated in FIG. 5, a cross-sectional view of the first plurality of channels may include a substantially flat or straight top and bottom edge with rounded sides/ends. The cross-sectional area may be that of a rounded rectangle. A long axis of this cross-section extending perpendicular to a radius of the tubular frame 206 may be longer than a short axis that runs parallel to the radius of the tubular frame 206. Each of the first plurality of channels may be substantially straight such that they run from a first open end of the tubular frame 206 to a second open end of the tubular frame 206.

Each of the first plurality of channels may be completely encased within the tubular frame 206 along the length of the first plurality of channels. However, the first plurality channels may form a first plurality of openings at the open end of the tubular frame 206 that mates with the first cover 304. Similarly, the first plurality channels may form a second plurality of openings at the second open end of the tubular frame 206 that mates with the second cover 306. These openings may have a cross-sectional area that are the same as the cross-section of the first plurality of channels. Turning back briefly to FIG. 3, before the first cover 304 and the second cover 306 are mated with the tubular frame 206, the first plurality of openings and the second plurality of openings may be visible when looking into either end of the tubular frame 206.

In some embodiments, the first plurality of channels 502 in the tubular frame 206 may be arranged in alternating pairs of channels. For example, FIG. 5 illustrates six pairs of channels in the tubular frame 206. One pair of channels 502a, 502b in the first plurality of channels may be positioned closer to each other than they are to other channels 502c, 502d. For example, spacing between the pair of channels 502a, 502b and other channels 502c, 502d may be approximately 90% of a width of the individual channels, while spacing between channel 502a and channel 502b may be less than approximately 25% of the width of the individual channels. The ratio of these spaces may be 3:1, 4:1, 5:1, 6:1, and so forth. After assembly, the connections between channels and openings in the motor assembly 300 may be such that coolant flows in a same direction in pairs of channels. For example, coolant may flow from the first cover 304 to the second cover 306 in both channel 502a and channel 502b.

In some embodiments, the cross-section of the first plurality of channels may be uniform throughout the length of the tubular frame 206. In other embodiments, the cross-section of the first plurality channels may change through the length of the tubular frame 206. For example, the cross-section of the first plurality of channels may gradually decrease in the direction of coolant flow to generate a pressure differential and force coolant through the tubular frame 206. In other embodiments, the cross-section of the first plurality of channels may gradually increase in the direction coolant flow.

The example of FIG. 5 illustrates six pairs of channels for a total of 12 channels in the tubular frame 206. This is merely provided by way of example and not meant to be limiting. Other embodiments may include substantially more or fewer channels, such as 10 channels, 8 channels, 6 channels, 13 channels, 14 channels, 15 channels, and/or the like. Additionally, although the first plurality of channels 502 are organized into pairs of channels, this is also done merely by way of example and not meant to be limiting. Other embodiments may use triplets of channels, single channels, and/or the like, with each grouping of channels carrying coolant in a same direction. It should also be noted that FIG. 5 is drawn to scale relative to the spacing and sizing of the channels.

The first cover 304 can be mated with the first open end of the tubular frame 206. A face of the first cover 304 may include a plurality of openings, referred to herein as a “third plurality of openings” that are configured to meet with the first plurality of openings on the corresponding edge of the tubular frame 206. The third plurality of openings on the first cover 304 may be sized to match the first plurality of openings on the tubular frame 206. Thus, when attaching the first cover 304 to the tubular frame 206, coolant can flow through the first plurality of openings into the third plurality of openings without restriction. Alternatively, the third plurality of openings may be substantially larger than the first plurality of openings on the tubular frame 206. This may be particularly true when the third openings expose an entire side of the channels in the first cover 304 as described below.

The third plurality of openings may be connected to additional channels in the first cover 304 referred to herein as a “second plurality of channels.” The second plurality of channels may connect ones of the first plurality of openings to others of the first plurality of openings. For example, sets of one or more openings may be connected to other sets of one or more openings. In the example of FIG. 5, each pair of first channels in the tubular frame 206 may connect to a corresponding one or more third openings in the first cover 304. One of the second channels in the first cover 304 can connect one pair of openings in the first cover 304 to another pair of openings as depicted in FIG. 5. Additionally, multiple ones of the first openings in the tubular frame 206 may be coupled to a single third opening in the first cover 304.

Each of the second plurality of channels may include one or more sections, each of which has differing flow characteristics. For example, FIG. 5 illustrates one of the second channels in the first cover 304 having a first section 504a, a second section 504b, and a third section 506. The first section 504a may be a mirror image of the second section 504b. These two sections may be joined together by the third section 506. The third section 506 may have a smaller cross-sectional area than that of either the first section 504a or the second section 504b. This may create a pressure differential in the flow of the coolant that helps ensure that coolant moves through the channels in the housing of the motor assembly 300.

Another feature of the second plurality of channels in the first cover 304 is the direction in which coolant flows around the motor assembly 300. In the tubular frame 206, coolant flows exclusively along an outside diameter of the tubular frame 206. This cools the motor assembly 306 along one surrounding surface. However, some embodiments also allow coolant to flow through the first cover 304 in a direction that is perpendicular to the central axis of the motor assembly 300. This allows coolant flowing through the second plurality of channels in the first cover 304 to also cool the motor assembly 300 along the front of the motor assembly 300. This results in a more uniform cooling of the motor assembly 300, rather than leaving hotter spots at the end(s) of the motor assembly 300. As depicted in FIG. 5, a direction of flow of the coolant may be oriented inward towards the axis of the motor assembly 300 through at least a portion of the second plurality of channels.

Just as the first cover 304 includes channels and openings that mate with the tubular frame 206 and complete a coolant route between the tubular frame 206 and the first cover 304, the second cover 306 may also do so in a similar fashion. The openings formed by the second cover 306 that mate with the second plurality of openings on the tubular frame 206 may be referred to herein as a “fourth plurality of openings.” Additionally, channels formed inside the second cover 306 may be referred to herein as a “third plurality of channels.” As described above for the first cover 304, the fourth plurality of openings may be configured or position to mate with the second plurality of openings of the tubular frame 206. Each of the third plurality of channels may connect ones of the second plurality of openings to others of the second plurality of openings through the fourth plurality of openings in the second cover 306.

In some embodiments, the third plurality of channels in the second cover 306 may also extend inwards towards a center axis of the motor assembly 300. The third plurality of channels may be arranged having a geometry similar to that of the channels/openings in the first cover 304. Alternatively, as illustrated in FIG. 5, the third plurality of channels may be configured to run directly between the second plurality of openings along an outer circumference of the second cover 306. In some embodiments, a portion of the third plurality of channels that goes between sets of the second plurality of openings may be narrower or have a smaller cross-sectional area than the other portions of the coolant pathway, such as the first plurality of channels in the tubular frame 206. By making these narrower, it ensures that coolant is driven quickly back into the first plurality of channels in the tubular frame 206 and does not linger in the third plurality of channels in the second cover 306.

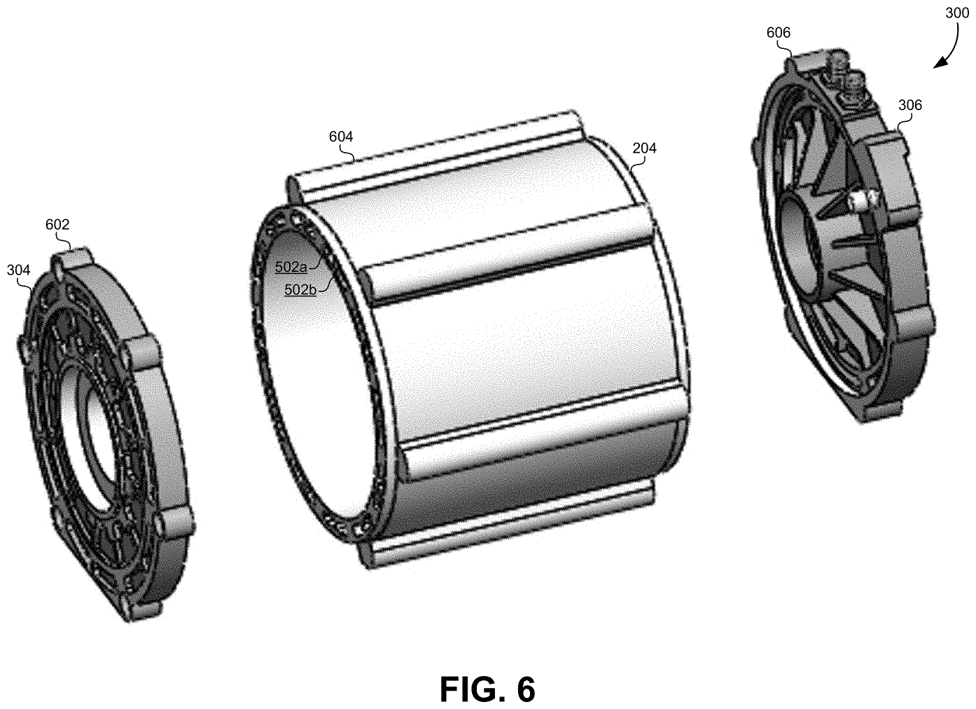

FIG. 6 illustrates how the first cover 304 and the second cover 306 can be mated with the tubular frame 204, according to some embodiments. As described above, the openings on each of these components can be visible fully when the components are not assembled. The alignment of the ridges 604 and/or the corresponding mounting holes 602, 606 on the first cover 304 and the second cover 306, respectively, can ensure that the pairs of the first plurality of channels line up correctly with the corresponding third plurality of openings on the first cover 304 and the fourth plurality of openings on the second cover 306. This arrangement does not complicate the manufacture and assembly of the motor assembly 300. Instead, simply lining up the ridges 604 and the mounting holes 602, 606 will ensure that the pathway for the coolant is formed correctly.

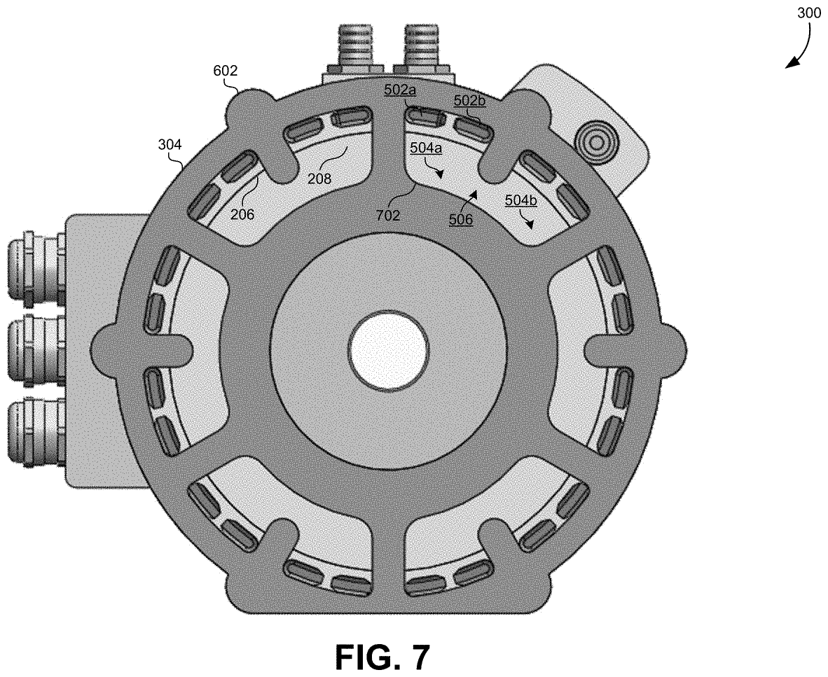

FIG. 7 illustrates a cross-sectional view of the front cover 304, according to some embodiments. This cross-sectional view more clearly shows how the second plurality of channels 702 may extend down into the first cover 304 to cool the front of the motor assembly 300. It also shows how the third section 506 of the second plurality of channels 702 may be narrower than the first section 504a and/or the second section 504b.

In some embodiments, the third plurality of openings in the first cover 304 need not match the size, shape, or number of the first plurality of openings in the tubular frame 206. Instead, a single opening in the first cover 304 may be configured to accept more than one of the first plurality of openings in the tubular frame 206. The same may be true of the fourth plurality of openings in the second cover 306. In some embodiments, the entirety of the second plurality of channels in the first cover 304 may be open and exposed before the first cover 304 is mated with the tubular frame 206. Thus, the third plurality of openings may share a complete side with the second plurality of channels in the first cover 304. This configuration is visible in FIG. 7, where the third plurality of openings and the second plurality of channels are closed by the stator 208 and the tubular frame 206.

Similarly, the fourth plurality of openings in the second cover 306 may also be completely open on the side adjacent to the tubular frame 206 as visible previously in FIG. 6. In this case, the fourth plurality of openings will share a complete side with the third plurality of channels in the second cover 306. For example, just as FIG. 7 illustrates how the open side of the second plurality of channels can be enclosed by the stator 208 and the edge of the tubular wall 206, the open side of the third plurality of channels can be enclosed by the opposite edge of the tubular wall 206 (not visible in FIG. 7). Thus, to form the fourth plurality of openings and the third plurality of channels, similar cavities to those illustrated in FIG. 7 can simply be machined from the body of the second cover 304.

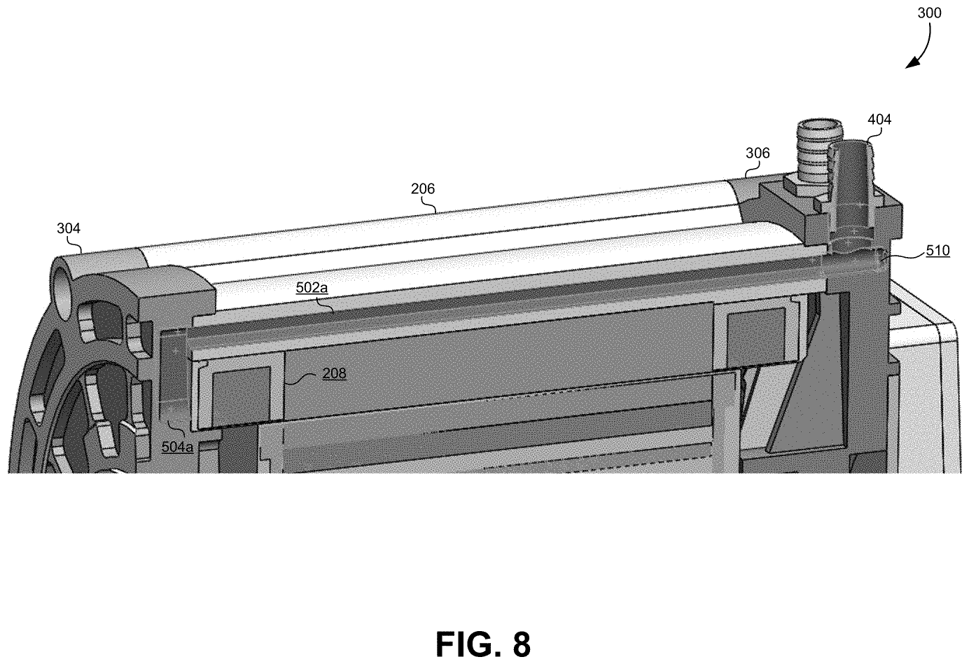

FIG. 8 illustrates a cross-sectional view of the motor assembly 300 in a plane that includes or is parallel to the central axis of the motor assembly 300, according to some embodiments. In particular, this figure illustrates how coolant can flow from the inlet valve 400 into the second cover 306, through one of the first plurality of channels 502a in the tubular frame 206, and into one of the second plurality of channels 504a in the first cover 304. This figure also illustrates how the openings on the first and second covers 304, 306 can be open along the entirety of the corresponding channels and how the corresponding channels can be enclosed by virtue of the stator 208 and/or the tubular frame 206 after assembly. This provides a particular advantage of placing coolant directly on the stator 208, which enhances the overall cooling of the motor assembly because the stator is where much of the heat generated by the motor resides.

FIG. 8 also illustrates how the coolant can change the direction of its flow to flow towards the center of the motor assembly 300 when passing through the one of the second plurality of channels 504a. Instead of traveling in a longitudinal direction along the outside of the cylinder, the direction of flow can change to an axial direction towards the center of the motor assembly. This causes the motor assembly to be more thoroughly encased by coolant loops, and thus more efficiently cooled by the mass of the motor assembly.

In the foregoing description, for the purposes of explanation, numerous specific details were set forth in order to provide a thorough understanding of various embodiments of the present disclosure. It will be apparent, however, to one skilled in the art that embodiments of the present disclosure may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A housing for cooling an electric motor in an electric vehicle, the housing comprising:
a tubular frame comprising a first end and a second end, wherein:
the first end comprising a first plurality of openings;
the second end comprises a second plurality of openings; and
the tubular frame comprises a first plurality of channels encased in the tubular frame running between the first plurality of openings and the second plurality of openings;
a first cover configured to mate with the first end of the tubular frame, the first cover comprising:
a third plurality of openings positioned to mate with the first plurality of openings of the tubular frame; and
a second plurality of channels that connects ones of the first plurality of openings to others of the first plurality of openings; and
a second cover configured to mate with the second end of the tubular frame, the second cover comprising:
a fourth plurality of openings positioned to mate with the second plurality of openings of the tubular frame; and
a third plurality of channels that connects ones of the second plurality of openings to others of the second plurality of openings;
wherein the first plurality of channels, the second plurality of channels, and the third plurality of channels form pathways through which coolant can flow.

2. The housing of claim 1, wherein the first plurality of channels are narrower than the second plurality of channels.

3. The housing of claim 1, wherein the first plurality of channels comprises alternating pairs of channels, wherein coolant flows in same directions in each of the pairs of channels.

4. The housing of claim 3, wherein each of the pairs of channels in the tubular frame comprises a space between the pairs of channels, wherein the space is less than 25% of a width of one of the first plurality of channels.

5. The housing of claim 1, wherein the third plurality of openings in the first cover comprises pairs of openings, wherein each of the pairs of openings receive coolant flowing in same directions.

6. The housing of claim 5, wherein each of the second plurality of channels in the first cover connects ones of the pairs of openings in the first cover to others of the pairs of openings in the first cover.

7. The housing of claim 1, wherein each of the second plurality of channels comprises a first section, a second section, and the third section, wherein the second section connects the first section to the third section, and wherein the second section is narrower than the first section and the third section.

8. The housing of claim 1, wherein the second plurality of channels extend to cover a portion of the first and of the tubular frame.

9. The housing of claim 1, wherein the second cover comprises an inlet valve and an outlet valve.

10. The housing of claim 9, wherein the coolant flows in through the inlet valve, through the first plurality of channels, the second plurality of channels, and the third plurality of channels, and out through the outlet valve.

11. An interior permanent magnet (IPM) motor comprising:
a stator having a plurality of conductors, the stator disposed concentrically around an axis;
a plurality of rotors disposed concentrically around the axis inside of the stator; and
a housing disposed concentrically around the axis, the housing comprising:
a tubular frame comprising a first end and a second end, wherein:
the first end comprising a first plurality of openings;
the second end comprises a second plurality of openings; and
the tubular frame comprises a first plurality of channels encased in the tubular frame running between the first plurality of openings and the second plurality of openings;
a first cover configured to mate with the first end of the tubular frame, the first cover comprising:
a third plurality of openings positioned to mate with the first plurality of openings of the tubular frame; and
a second plurality of channels that connects ones of the first plurality of openings to others of the first plurality of openings; and
a second cover configured to mate with the second end of the tubular frame, the second cover comprising:
a fourth plurality of openings positioned to mate with the second plurality of openings of the tubular frame; and
a third plurality of channels that connects ones of the second plurality of openings to others of the second plurality of openings;
wherein the first plurality of channels, the second plurality of channels, and the third plurality of channels form pathways through which coolant can flow.

12. The IPM motor of claim 11, wherein the first plurality of channels are narrower than the second plurality of channels.

13. The IPM motor of claim 11, wherein the first plurality of channels comprises alternating pairs of channels, wherein coolant flows in same directions in each of the pairs of channels.

14. The IPM motor of claim 13, wherein each of the pairs of channels in the tubular frame comprises a space between the pairs of channels, wherein the space is at least 1/10 of a width of one of the first plurality of channels.

15. The IPM motor of claim 11, wherein the third plurality of openings in the first cover comprises pairs of openings, wherein each of the pairs of openings receive coolant flowing in same directions.

16. The IPM motor of claim 15, wherein each of the second plurality of channels in the first cover connects ones of the pairs of openings in the first cover to others of the pairs of openings in the first cover.

17. The IPM motor of claim 11, wherein each of the second plurality of channels comprises a first section, a second section, and the third section, wherein the second connects the first section to the third section, and wherein the second section is narrower than the first section and the third section.

18. The IPM motor of claim 11, wherein the second plurality of channels extend to cover a portion of the first and of the tubular frame.

19. The IPM motor of claim 11, wherein the second cover comprises an inlet valve and an outlet valve.

20. The IPM motor of claim 19, wherein the coolant flows in through the inlet valve, through the first plurality of channels, the second plurality of channels, and the third plurality of channels, and out through the outlet valve.
